(19) United States
(12) Patent Application Publication
(10) Pub. No.: US 2007/0079109 A1
(43) Pub. Date: Apr. 5, 2007

(54) Simulation apparatus and simulation method

(75) Inventor: Atsushi Ike, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/299,894

(22) Filed: Dec. 13, 2005

(30) Foreign Application Priority Data
Sep. 30, 2005 (JP) 2005-286751

(51) Int. Cl. G06F 15/00

(52) U.S. Cl. 712/23

(57) ABSTRACT

A simulation apparatus capable of performing processing at a higher speed. The simulation apparatus is for VLIW processors, and includes a storage section for storing a program file which has a VLIW instruction formed of a predetermined instruction group, an instruction reading section for reading the program file from the storage section, an instruction decoding section for decoding the VLIW instruction in the read program file and, in both cases when the predetermined instruction group includes instructions which interfere with each other and when the predetermined instruction group includes an instruction which may cause an exception, for obtaining information used to identify the instructions or the instruction concerned, as decoding information, a decoding-information holding section for holding the obtained decoding information, and an instruction execution section for executing the VLIW instruction by using the decoding information when the decoding-information holding section stores the decoding information.

### CROSS-REFERENCE TO RELATED APPLICATIONS

This application is based upon and claims the benefits of priority from the prior Japanese Patent Application No. 2005-286751, filed on Sep. 30, 2005, the entire contents of which are incorporated herein by reference.

### BACKGROUND OF THE INVENTION

1. Field of the Invention

The present invention relates to simulation apparatuses and simulation methods, and particularly to a simulation apparatus and a simulation method for very-long-instruction-word (VLIW) processors.

2. Description of the Related Art

In digital consumer units which process image data and audio data, for example, the processing performance of processors mounted therein determines image quality and sound quality obtained at recording and reproduction. Therefore, a demand for higher-speed, higher-performance processors has been increased every year in order to implement high image quality and high sound quality.

In an architecture for such processors, a very-long-instruction-word (VLIW) technique has been frequently used. In the VLIW technique, a plurality of basic instructions, such as an operation instruction, a load instruction, a store instruction, and a branch instruction, is placed in one very long instruction word, and the instructions are processed in parallel by a plurality of function units (pipeline) in the processor. In other words, with the use of parallelism at a program instruction level, plural instructions which are independent from each other are assigned to different function units and are concurrently executed.

However, relatively a few processors employ the VLIW technique. Wide-spread processors read an instruction word formed of a single instruction one by one and execute it. A simulation method has been known (such as that disclosed in Japanese Unexamined Patent Application Publication No. 2002-304292) for simulating the operation of a VLIW-architecture machine with the use of a usual-architecture machine, in order to provide an environment for developing programs for VLIW processors.

To form a conventional simulator for VLIW processors, it is necessary to temporarily store the execution result of each instruction in a temporary area and to write the result in a register file when all instructions have been executed.

FIG. 5 is a view showing an example VLIW instruction in the simulation method. FIG. 6 shows a control flow of executing the instruction shown in FIG. 5.

For a simple description, the contents of a register file “gr1” are indicated by “gr1a”, “gr1b”, and “gr1c” in an appearance order in FIG. 5. In addition, “1-VLIW” indicates a group of instructions executed in parallel in a VLIW instruction.

In the case shown in FIG. 5 and FIG. 6, an “add.p” instruction obtains the sum of “gr1a” and “gr2” and stores the sum in “gr1” (changes “gr1a” to “gr1b” (new gr1)), but “gr1c” used in an “ld” instruction needs to have the same value as “gr1a” (old gr1) . Therefore, the simulator cannot update the content (“gr1a”) of the register file “gr1” immediately after the “add.p” instruction is executed. Conventionally, as shown in FIG. 6, the contents of a register file are temporarily stored in a temporary area and are written into the register file when all instructions in the VLIW instruction have been executed.

FIG. 7 shows another VLIW instruction. In FIG. 7, it appears that the above-described issue does not occur because there are no relationships among “gr1”, “gr2”, “gr3”, used in an “add.p” instruction and “gr4”, “gr5”, and “gr6” used in an “ld” instruction. However, the “ld” instruction may cause an exception such as a memory fault. If the exception is a strict exception, the contents of register files (“gr3” and “gr6” in the case of FIG. 7) cannot be updated immediately after the “ld” instruction.

The above-described instruction is converted to several instructions in a host processor when the instruction is made to be processed just in time (JIT). If it is necessary to write data into a register file by using a temporary area, this writing processing is a heavier load than the original instruction processing.

Although only a few instructions need a temporary buffer in their execution and the other instructions, which are most instructions in VLIW instructions, do not need the temporary buffer, data is conventionally written into a register file when all instructions in each VLIW instruction have been executed. More specifically, the conventional method generates a processing delay caused by an increased number of processes because, the less the number of instructions required at a host processor for the original one instruction becomes with the use of other higher-speed technologies, the more the number of instructions which require data to be written into the register file by using a temporary area becomes.

### SUMMARY OF THE INVENTION

In view of the foregoing, the present invention has been made, and it is an object of the present invention to provide a simulation apparatus and a simulation method which allow processing to be performed at a higher speed.

To accomplish the above object, according to the present invention, there is provided a simulation apparatus for VLIW processors. The simulation apparatus includes a storage section for storing a VLIW instruction formed of a predetermined instruction group, an instruction reading section for reading the VLIW instruction from the storage section, an instruction decoding section for decoding the read VLIW instruction and, in both cases when the predetermined instruction group includes instructions which interfere with each other and when the predetermined instruction group includes an instruction which may cause an exception, for obtaining information used to identify the instructions or the instruction concerned, as decoding information, a decoding-information holding section for holding the obtained decoding information, and an instruction execution section for executing the VLIW instruction by using the decoding information when the decoding-information holding section stores the decoding information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows a basic configuration of a simulation apparatus according to an embodiment of the present invention.

FIG. 2 shows an example hardware structure of the simulation apparatus.

FIG. 3 is a block diagram showing the functions of the simulation apparatus.

FIG. 4 is a flowchart showing the operation of the simulation apparatus.

FIG. 5 shows an example VLIW instruction to which a simulation method according to the present invention is applied.

FIG. 6 shows a control flow used when the VLIW instruction shown in FIG. 5 is executed.

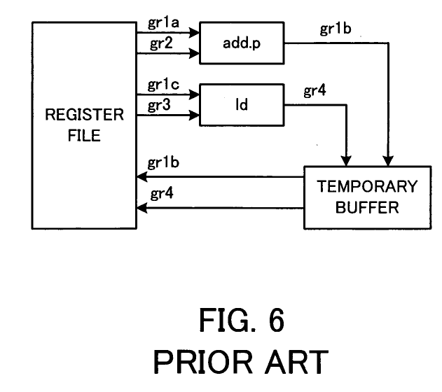

FIG. 7 shows another example VLIW instruction.

### DESCRIPTION OF THE PREFERRED EMBODIMENTS

An embodiment of the present invention will be described below in detail by referring to the drawings.

The outline of the present invention will be described first, and then the embodiment will be described.

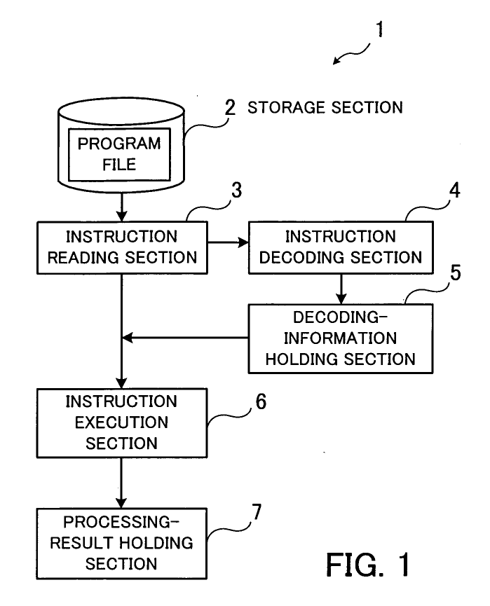

FIG. 1 shows a basic configuration of a simulation apparatus 1 according to the present invention.

The simulation apparatus 1 shown in FIG. 1 simulates an architecture, and is used to develop programs, evaluate the performance, and others. The simulation apparatus 1 includes a storage section 2, an instruction reading section 3, an instruction decoding section 4, a decoding-information holding section 5, an instruction execution section 6, and a processing-result holding section 7.

The storage section 2 stores a program file having a VLIW instruction formed of a predetermined instruction group. The predetermined instruction group includes an instruction or instructions executed in parallel by a VLIW processor.

The instruction reading section 3 reads the program file having the VLIW instruction from the storage section 2.

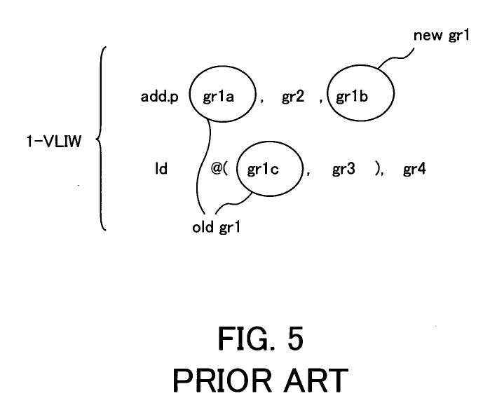

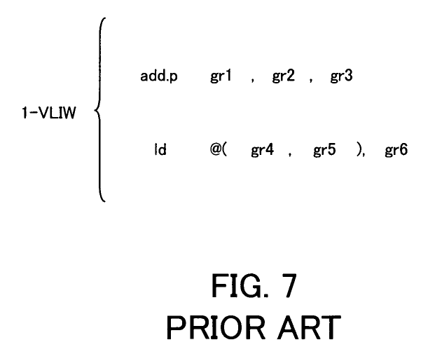

The instruction decoding section 4 decodes the program file read by the instruction reading section 3. In decoding, the instruction decoding section 4 obtains and outputs decoding information used to identify instructions which mutually interfere with each other in the predetermined number of instructions or which may cause an exception such as an instruction violation or an interrupt, as shown in FIG. 5 or FIG. 7.

The decoding-information holding section 5 holds the decoding information output from the instruction decoding section 4.

The instruction execution section 6 executes the VLIW instruction included in the program file read by the instruction reading section 3. When decoding information is stored in the decoding-information holding section 5, the instruction execution section 6 uses the decoding information.

The processing-result holding section 7 holds the result of processing performed by the instruction execution section 6.

In the simulation apparatus 1, decoding information such as a signal and an interrupt is held when an VLIW instruction is executed, and the decoding information is used when the corresponding instruction(s) is executed again.

An embodiment of the present invention will be specifically described below.

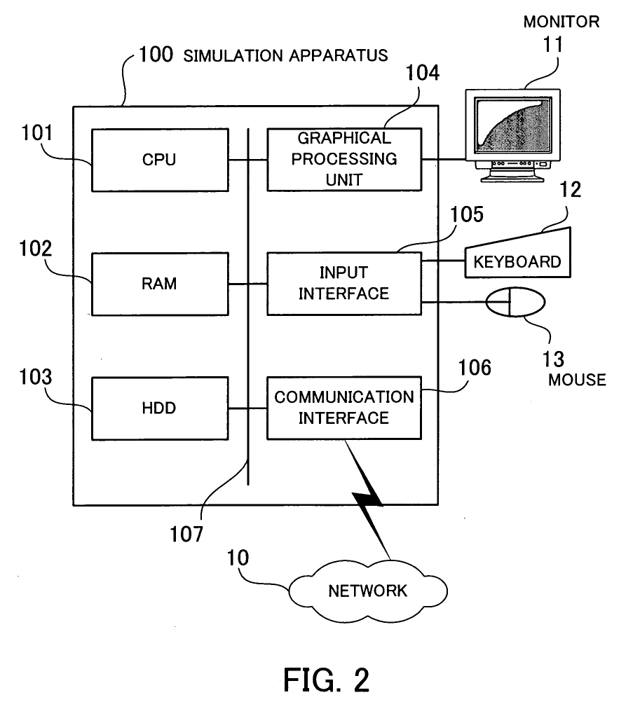

FIG. 2 shows an example hardware structure of a simulation apparatus 100 according to the embodiment.

The whole of the simulation apparatus 100 is controlled by a central processing unit (CPU) 101. The CPU 101 is connected to a random access memory (RAM) 102, a hard disk drive (HDD) 103, a graphical processing unit 104, an input interface 105, and a communication interface 106, through a bus 107.

The RAM 102 temporarily stores at least a part of an operating system and an application program to be executed by the CPU 101. The RAM 102 also stores various types of data required for processing performed by the CPU 101. The HDD 103 stores the operating system and the application program. The HDD 103 also stores a program file.

The graphical processing unit 104 is connected to a monitor 11. According to an instruction sent from the CPU 101, the graphical processing unit 104 displays an image on the screen of the monitor 11. The input interface 105 is connected to a keyboard 12 and a mouse 13. The input interface 105 transmits a signal sent from the keyboard 12 or the mouse 13, to the CPU 101 through the bus 107.

The communication interface 106 is connected to a network 10. The communication interface 106 exchanges data with other computers through the network 10.

With the above-described hardware configuration, processing functions in the present embodiment are implemented. The simulation apparatus l00 is provided with the following functions in order to perform simulation.

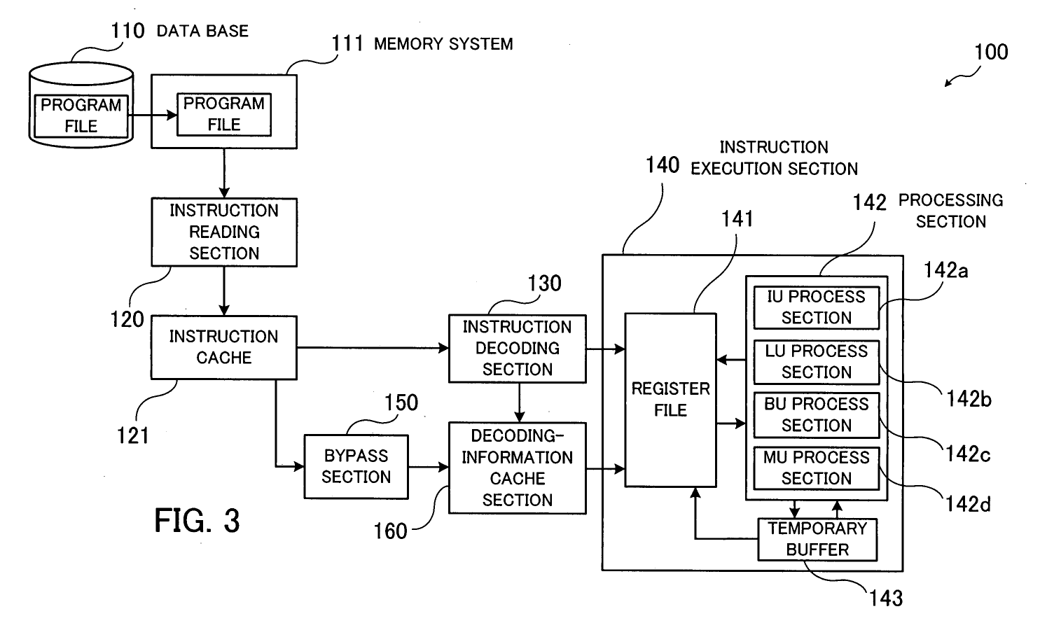

FIG. 3 is a block diagram showing the functions of the simulation apparatus 100.

The simulation apparatus 100 includes a data base 110, a memory system 111, an instruction reading section 120, an instruction cache 121, an instruction decoding section 130, an instruction execution section 140, a bypass section 150, and a decoding-information cache section 160.

The data base 110 stores a program file having all instructions included in one VLIW instruction to be simulated, in other words, a program file necessary for simulation.

The program file read from the data base 110 is loaded to the memory system 111.

The instruction reading section 120 reads the program file stored in the memory system 111.

The instruction cache 121 caches the program file read by the instruction reading section 120. When the decoding-information cache section 160 does not have decoding information, for example, when the simulation apparatus 100 executes a VLIW instruction for the first time, the instruction reading section 120 outputs the read program file to the instruction decoding section 130. When a second or subsequent VLIW instruction is executed, the instruction reading section 120 outputs the read program file to the bypass section 150.

The instruction decoding section 130 decodes the program file stored in the instruction cache 121. The instruction decoding section 130 checks whether the decoded VLIW instruction includes an instruction which causes register interference or which can cause an exception, and, if any, outputs the instruction to the decoding-information cache section 160 as decoding information.

The instruction execution section 140 includes a register file 141, a processing section 142, and a temporary buffer 143.

The instruction execution section 140 executes instructions of the predetermined instruction group included in the VLIW instruction of the input program file. More specifically, the instruction execution section 140 identifies a function unit which should be used in a VLIW processor to process the VLIW instruction included in the program file.

The instruction execution section 140 uses the decoding information stored in the decoding-information cache section 160, if any, to execute the instructions.

The register file 141 has a writing register for holding the execution state of the VLIW instruction.

The processing section 142 has an IU process section 142a, an LU process section 142b, a BU process section 142c, and an MU process section 142d.

The processing section 142 executes the instructions output from the register file 141. Specifically, the IU process section 142a performs an operation process, the LU process section 142b executes a load instruction and a store instruction, the BU process section 142c executes a branch instruction, and the MU process section 142d executes an accumulator operation instruction and an accumulator reading instruction, or an accumulator writing instruction. Each process section outputs (writes back) the result of execution to the register file 141.

The temporary buffer 143 temporarily stores the content of the writing register included in the register file 141, if necessary, when the processing section 142 executes an instruction, and writes back the content into the writing register of the register file 141 every time when the predetermined instruction group included in the VLIW instruction has been executed.

The bypass section 150 bypasses the program file when a second or subsequent VLIW instruction is executed through the instruction reading section 120, as described above.

The decoding-information cache section 160 applies cached decoding information to the program file output from the bypass section 150, and outputs the result.

The operation of the simulation apparatus 100 will be described next.

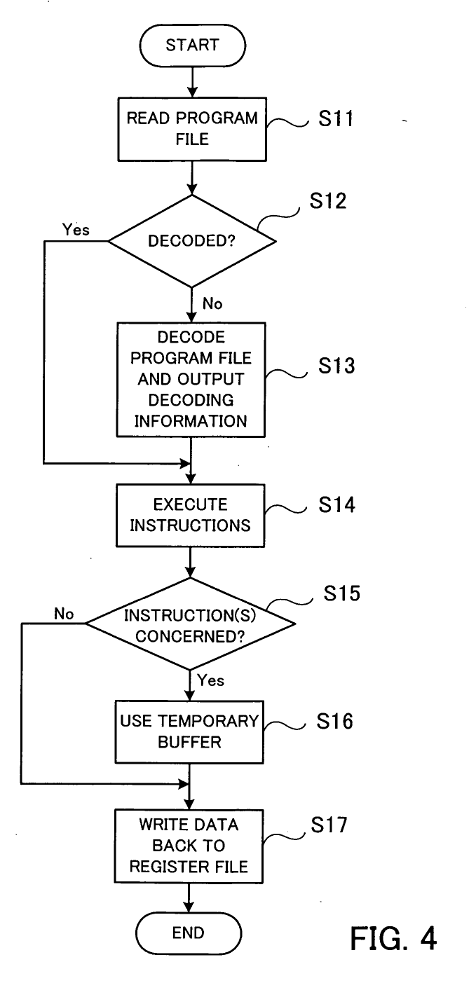

FIG. 4 is a flowchart of the operation of the simulation apparatus 100.

First in step S11, the instruction reading section 120 reads the program file stored in the memory system 111, and outputs it to the instruction cache 121.

Then, in step S12, the instruction reading section 120 determines whether the program file has been decoded, in other words, whether the decoding-information cache section 160 has the corresponding decoding information. When the program file has been decoded (yes in step S12), the procedure proceeds to step S14. When the program file has not been decoded (no in step S12), the instruction decoding section 130 decodes the program file, and outputs decoding information to the decoding-information cache section 160, in step S13.

In step S14, the instruction execution section 140 executes instructions in the predetermined instruction group included in each VLIW instruction stored in the input program file. In execution, the instruction execution section 140 determines in step S15 whether there is an instruction corresponding to the decoding information. When there is an instruction corresponding to the decoding information (yes in step S15), the instruction execution section 140 uses the temporary buffer 143 in step S16 to write data back into the writing register of the register file 141 in step S17 every time when the predetermined instruction group included in each VLIW instruction has been executed. As for an instruction which may cause an exception, only when the exception did not occur, the instruction execution section 140 writes data from the temporary buffer 143 back to the writing register of the register file 141.

When there is not an instruction corresponding to the decoding information (no in step S15), the instruction execution section 140 writes data into the writing register of the register file 141 during execution, and also writes, without using the temporary buffer 143, the result of processing in the processing section 142 directly into the writing register of the register file 141 in step S17. The simulation apparatus 100 repeats the processes of steps S14 to S17 for each VLIW instruction included in the input program file.

Even when a new program file is written in the memory system 111, if the previous instruction-cache data exists, the decoding information stored in the decoding-information cache section 160 continues to be effective (the decoding information continues to remain in the decoding-information cache section 160). When the instruction cache 121 is disabled, the decoding-information cache section 160 is also disabled in order to avoid inconsistency with the logical operation of the CPU 101.

As described above, according to the simulation apparatus 100 of the present embodiment, the instruction decoding section 130 determines whether instructions which cause register interference or an instruction which may cause an exception exists in a program file to be processed, and if any, caches the corresponding decoding information in the decoding-information cache section 160. By re-using the decoding information, VLIW instructions which are included in program files subsequently read from the data base 110 and which do not correspond to the decoding information can be sequentially executed without using the temporary buffer 143. Therefore, the processing is performed at a higher speed.

In the above-described embodiment, when the simulation apparatus 100 executes a VLIW instruction for the first time, the read program file is sent to the instruction decoding section 130, and when the simulation apparatus 100 executes a second or subsequent VLIW instruction, the read program file is sent to the bypass section 150. However, a program file may be sent to the instruction decoding section 130 at any desired time. In this case, the instruction decoding section 130 performs the above-described operation every time when a program file is sent in, and when the decoding-information cache section 160 already stores decoding information, if the instruction decoding section 130 outputs another decoding information, the decoding-information cache section 160 updates the existing decoding information to the another decoding information and holds it. With this, when the current VLIW instruction is overwritten, the decoding information can also be promptly updated. Decoding information corresponding to a program file used can be obtained.

A simulation apparatus and a simulation method according to a preferred embodiment of the present invention have been described in detail. The present invention is not limited to the embodiment. A simulation apparatus and a simulation method according to the present invention are mainly applied, for example, to VLIW processors, but can also be applied to other cases having similar execution forms, such as horizontal-microprogram simulation.

In the present invention, an instruction decoding section determines whether instructions included in a predetermined instruction group interfere with each other and also determines whether the instructions may cause an exception, and if any, obtains information used to identify the instruction(s) concerned, as decoding information. A decoding-information holding section holds the decoding information. Since the decoding information can be re-used when a subsequent VLIW instruction is executed, processing can be performed at a higher speed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A simulation apparatus for VLIW processors, comprising:
a storage section for storing a VLIW instruction formed of a predetermined instruction group;
an instruction reading section for reading the VLIW instruction from the storage section;
an instruction decoding section for decoding the read VLIW instruction and, in both cases when the predetermined instruction group includes instructions which interfere with each other and when the predetermined instruction group includes an instruction which may cause an exception, for obtaining information used to identify the instructions or the instruction concerned, as decoding information;
a decoding-information holding section for holding the obtained decoding information; and
an instruction execution section for executing the VLIW instruction by using the decoding information when the decoding-information holding section stores the decoding information.

2. The simulation apparatus according to claim 1, further comprising an instruction cache for caching the read VLIW instruction,
wherein the instruction decoding section handles the instruction included in the instruction cache.

3. The simulation apparatus according to claim 1, wherein, when a new instruction is written in a memory, the decoding-information holding section discards the decoding information used before the new instruction is written.

4. The simulation apparatus according to claim 1, further comprising:
a register file for holding the value of each variable used when the VLIW instruction is executed; and
a temporary buffer for storing the value of the variable before the value is stored in the register file,
wherein the instruction execution section sequentially executes the VLIW instruction, and, when the instructions which interfere with each other exist, stores the value of the variable in the temporary buffer during the execution and stores the value of the variable into the register file from the temporary buffer after the execution.

5. The simulation apparatus according to claim 1, further comprising:
a register file for holding the value of each variable used when the VLIW instruction is executed; and
a temporary buffer for storing the value of the variable before the value is stored in the register file,
wherein the instruction execution section sequentially executes the VLIW instruction, and, when the instruction which may cause an exception exists, stores the value of the variable in the temporary buffer during the execution and stores, if the exception did not occur, the value of the variable into the register file from the temporary buffer.

6. The simulation apparatus according to claim 1, further comprising a register file for holding the value of each variable used when the VLIW instruction is executed,
wherein the instruction execution section sequentially executes the VLIW instruction, and, when the instructions which interfere with each other do not exist and the instruction which may cause an exception does not exist, stores the value of the variable directly into the register file after the instruction is executed.

7. The simulation apparatus according to claim 1, wherein the decoding information is obtained when the read VLIW instruction is decoded for the first time.

8. A simulation method for VLIW processors, comprising the steps of:
storing a VLIW instruction formed of a predetermined instruction group;
reading the VLIW instruction;
decoding the read VLIW instruction and, in both cases when the predetermined instruction group includes instructions which interfere with each other and when the predetermined instruction group includes an instruction which may cause an exception, obtaining information used to identify the instructions or the instruction concerned, as decoding information;
holding the obtained decoding information; and
executing the VLIW instruction by using the decoding information when the decoding information is held.
